(19) United States
(12) Patent Application Publication
(10) Pub. No.: US 2024/0355088 A1
(43) Pub. Date: Oct. 24, 2024

(54) METHOD FOR MATCHING A CANDIDATE IMAGE WITH A REFERENCE IMAGE

(71) Applicant: KERQUEST, CHINDRIEUX (FR)

(72) Inventors: Yann BOUTANT, CHINDRIEUX (FR); Gaël ROSSET, CHINDRIEUX (FR)

(21) Appl. No.: 18/683,500

(22) PCT Filed: Aug. 31, 2022
(86) PCT No.: PCT/EP2022/074254

§ 371 Date: Feb. 13, 2024

(30) Foreign Application Priority Data
Sep. 1, 2021 (FR) FR2109141

(51) Int. Cl. G06V 10/75; G06T 7/32; G06T 7/33; G06V 10/74; G06V 10/764

(52) U.S. Cl. CPC G06V 10/751; G06T 7/32; G06T 7/337; G06V 10/753; G06V 10/757; G06V 10/758; G06V 10/759; G06V 10/761; G06V 10/764

(57) ABSTRACT

A method for correlating at least part of a candidate image (Ican) with at least one reference image, includes the following steps: a) implementing a relational repository (R) comprising at least: an ordered list of relational descriptors, at least one computing mode to be applied to the images in order to determine descriptors of these images, and a mode for determining the degree of similarity between two descriptors, b) implementing, for each reference image, a reference list that comprises the positions, referred to as reference points of interest, in the reference image, of descriptors of the reference image that are similar to relational descriptors from a relational repository compatible with the relational repository implemented in step a), which reference list is ordered on the basis of the order of this compatible relational repository, c) determining, in the candidate image, descriptors of the candidate image that are computed in line with each descriptor computing mode of the relational repository implemented in step a), and determining the position of each of these descriptors in the candidate image, d) determining the degree of similarity, determined in line with the determination mode of the relational repository implemented in step a), between each descriptor of the candidate image and each relational descriptor of the relational repository implemented in step a), e) determining a candidate list that comprises the positions, referred to as candidate points of interest, in the candidate image, of the descriptors of the candidate image exhibiting the greatest similarity with the relational descriptors of the relational repository implemented in step a), which candidate list is ordered on the basis of the order of this relational repository, f) processing the candidate list with respect to each reference list on the basis of the order of the candidate and reference lists.

### CROSS-REFERENCE TO RELATED APPLICATIONS

This application is a National Stage of International patent application PCT/EP2022/074254, filed on Aug. 31, 2022, which claims priority to foreign French patent application No. FR 2109141, filed on Sep. 1, 2021, the disclosures of which are incorporated by reference in their entireties.

### FIELD OF THE INVENTION

The present invention relates to the correlation of images, and more particularly to the correlation of at least part of a candidate image with at least one reference image, with a view to comparing or confronting it with this reference image. The present invention relates more particularly to the technical field of image or point registration, and the recognition of tangible subjects (for example objects), notably in order to assess whether a tangible subject belongs to a predetermined class of tangible subjects. In practice, the present invention relates to a method for correlating at least part of a candidate image with at least one reference image. The present invention also relates to a method for creating a set of reference lists from a plurality of reference images, notably with a view to implementing the correlation method according to the invention.

### BACKGROUND

Various image registration methods are known, which directly compare two images of comparable nature in order to bring them closer together or even superimpose them. Some of these very widespread registration methods directly and independently determine, in two images to be compared, points of interest and their associated local descriptors, and then attempt to successively match said local descriptors, and therefore homologous points of interest between the images. Finally, they look for whether there is an optimum geometric transformation linking these two images, and apply it, where applicable, to one of the two in order to effectively register the images.

Some object recognition methods are also known that are based on image analysis and direct comparison of the values of the elements of an image of a tangible subject with those of an image of a similar tangible subject (identical or of the same model), based on the global distribution of local attributes (texture, color, etc.) matched between said images.

Thus, these existing methods first identify descriptors appropriately describing each of the images, and then systematically and independently compute, in each image, points of interest corresponding to these descriptors. This leads to the need for a specific additional step of matching the descriptors and points of interest, which is burdensome in terms of computing and detrimental in terms of time and resources.

These known registration and recognition methods therefore exhibit limitations with regard to their implementation, in particular in terms of efficiency, computing speed or adaptability to specific cases. Moreover, these known methods are poor at discriminating relevant points of interest (in the sense of the desired objective) from irrelevant points, that is to say these known methods have a poor signal-to-noise ratio. Indeed, these methods are generally slow and not very economical in terms of computing resources, meaning that they are poorly suited to correlating a set of disparate images, registering them and/or comparing them with a view to recognizing them or classifying them according to predetermined classes. These methods remain very difficult to implement in real time on mobile terminals such as smartphones as soon as fine recognition performance is expected.

There is therefore a real need to facilitate the correlation of images and to improve the performance thereof in order to allow new applications. The present invention proposes to achieve this objective.

The present invention thus relates to a method for correlating at least part of a candidate image with at least one reference image, comprising the following steps:
a) implementing a relational repository comprising at least: an ordered list of relational descriptors, at least one computing mode to be applied to the images in order to determine descriptors of these images, and a mode for determining the degree of similarity between two descriptors,
b) implementing, for each reference image, a reference list that comprises the positions, referred to as reference points of interest, in the reference image, of descriptors of the reference image that are similar to relational descriptors from a relational repository compatible with the one implemented in step a), which reference list is ordered on the basis of the order of this compatible relational repository, c) determining, in the candidate image, descriptors of the candidate image that are computed in line with each descriptor computing mode of the relational repository implemented in step a), and determining the position of each of these descriptors in the candidate image, d) determining the degree of similarity, determined in line with the determination mode of the relational repository implemented in step a), between each descriptor of the candidate image and each relational descriptor of the relational repository,
e) determining a candidate list that comprises the positions, referred to as candidate points of interest, in the candidate image, of the descriptors of the candidate image exhibiting the greatest similarity with the relational descriptors of the relational repository implemented in step a), which candidate list is ordered on the basis of the order of this relational repository,
f) processing the candidate list with respect to each reference list on the basis of the order of the candidate and reference lists.

It should be noted that, within the meaning of the invention, the steps are not necessarily carried out in the sequential order in which they are listed: they may notably be carried out in the opposite order or simultaneously. On the contrary, it is important that step c) is carried out before step d), which itself should be carried out before step e), at least for each image descriptor, these steps being able to be carried out simultaneously and in parallel for various image descriptors. However, steps c) to e) are not necessarily consecutive, since intermediate steps may of course be interposed between these steps c) to e), for example step b). Finally, step f) necessarily follows the creation of the candidate list as provided in step e) and the implementation of at least one reference list as provided in step b).

Within the meaning of the invention, an “image”, whether a candidate image or reference image, is understood to mean any type of image in the general sense of the term, and not just an image comparable to a photograph. In other words, an image is not limited to the sole meaning of an optical image resulting from the authentication region being subjected to visible light radiation, but may, on the contrary, be obtained by any type of physical action, among which mention may be made notably of: ultrasound, far infrared, terahertz radiation, X-ray or gamma radiation, X-ray or laser tomography, X-ray radiography, magnetic resonance, without this list being limiting or exhaustive. Thus, within the meaning of the invention, an image is for example the recording of the result of the stimulation, by any means, of a natural scene or of a tangible subject. This recording may then be said to be a natural image. This recording is able to have a single dimension, then corresponding for example to the recording of the variation, over time or along a line, of a single signal, or else the recording of the values of a line of sensors. This recording is also able to have two dimensions, as is the case of a photograph, which may be recorded in half-tones, in grayscale or else in color. Within the meaning of the invention, an “image” may therefore be a 1D signal, a 2D or 3D grayscale or color image, or else an nD (n-dimensional) signal, for example a hyper-spectral or RGB-D signal. Within the meaning of the invention, an “image” may be the result of a single acquisition or extracted from a stream. Thus, within the scope of the invention, an “image” may be extracted from a video stream. In one mode of implementation, the image may be saved in digital form. In addition, an image implemented in the method according to the invention may be an image that has been segmented beforehand, notably when it comprises multiple tangible subjects in one and the same scene or a repetition of one and the same pattern. Of course, an image is not necessarily natural and may be synthetic, that is to say it may be generated by a computerized process with or without the assistance of a human operator. Within the scope of the invention, a natural image and a synthetic image have the common characteristic whereby they are in one and the same digital or analog recording format with a view to being processed as part of one and the same process. Optical and/or digital pre-processing operations to improve the image may also be applied thereto in order to achieve a better signal-to-noise ratio, for example. It is thus possible to apply for example an optical zoom (devices with variable focal lengths) and/or digital zoom in order to better select the observation scale, image deconvolution in order to eliminate a focus defect or a movement, bandpass filtering in order to select/prioritize intermediate-frequency details, or contrast enhancement in order to accentuate contrast.

An image is said to be a “reference” image in that it is known before the method is implemented. The reference image preferably results from a snapshot taken before the method is implemented. The reference image may also be a synthetic image, that is to say for example an image constructed from images of tangible subjects or tangible scenes, or an image resulting from a pure computerized synthesis process, or else an image combining these two embodiments. The reference image forms part of the parameters chosen a priori in the implementation of the method according to the invention. The reference image is recorded or even certified by a trusted third party.

An image is said to be a “candidate” image in that it is implemented in order to question its degree of local correlations with a reference image. The candidate image is preferably a natural image in that it is the result of the acquisition of a signal resulting from the stimulation of a tangible subject and/or of a scene comprising one or more tangible subjects. The candidate image results generally, but not exclusively, from an acquisition carried out just before the method according to the invention is implemented.

Preferably, the candidate image and the one or more reference images with which it is correlated (via the method according to the invention) result from one and the same type of physical action (for example subjecting to visible light radiation when the images are from a photograph of tangible subjects in globally diffuse visible light).

Within the meaning of the invention, a “descriptor” is a computerized or digital object, a data structure, for summarizing certain local properties of an image. Thus, when applied to an image, a descriptor is associated with its location in the image, that is to say with the location or the area of the image that has the characteristics defined by the descriptor or corresponding to the descriptor. Within the scope of the invention, this location is also called “position”, salient point or noteworthy point. The descriptors may be of different natures and/or forms. In the case of an image in the sense of photography or a two-dimensional color image, the descriptors may be geometric in nature, for example corners, vertical or horizontal lines, or letters; colorimetric in nature, for example local maxima of the luminance gradient or a local contrast; or else spectral in nature, without this list being exhaustive. The descriptors may also be varied in nature, that is to say be the result of a machine learning process or else be constructed in order to implement the method of the invention in a particular context. A descriptor may be in the form of a matrix (a vector, a patch, etc.) or else of a graph (planar or not, an n-ary tree or not, etc.) or any other data structure, for example a value or a number.

Within the scope of the invention, and by metonymy, a descriptor also denotes the result of a computing mode that, once applied to the constituent data of an image, makes it possible, via the data structure that corresponds to the descriptor, to describe relevant predefined characteristics within said image. Examples of descriptor computing modes are as follows: HARRIS, SIFT, SURF, ORB, KAZE, RGB, VGG-16, which make it possible to search for example for corners, invariant elements with various characteristics, and colors. A descriptor therefore makes it possible to classify any given point of an image and its neighborhood, in line with one or more chosen or learned characteristics, for example on the basis of local texture or contrast, the presence of a given shape, color, its intensity, or else color gradient, the local distribution of the orientation of the gradient of a component of the image, or else many other characteristics. An image descriptor computing mode, applied to the points of an image, makes it possible to extract any noteworthy points, where the local characteristics represented by the descriptor are intrinsically present to a sufficient extent, that is to say in practice the points where the degree of relevance of the descriptor resulting from the computing mode is high enough. The set of noteworthy or salient points usually constitutes an intrinsic representation of the content of the image.

In practice, the image descriptor computing mode also makes it possible to define the coordinates that are associated with the noteworthy points of the descriptor in the image, in a chosen coordinate system that is for example, in the context of two-dimensional or three-dimensional spaces, a Cartesian, polar or cylindrical coordinate system.

Within the meaning of the invention, a “relational repository” is understood to mean a set of computerized or digital objects allowing images to be correlated, comprising at least:

an ordered list of what are referred to as “relational” descriptors; and

for each relational descriptor in the ordered list, at least one computing mode to be applied to a given image in order to determine descriptors of this image, and a mode for determining the degree of similarity between said relational descriptor and each of the image descriptors associated with this relational descriptor.

The relational repository forms part of the parameters chosen a priori (that is to say upstream) of the implementation of the method according to the invention.

Two types of descriptors are used here: on the one hand, “relational descriptors” that are chosen and ordered in the list contained in the relational repository and, on the other hand, “descriptors” of the reference and candidate images, which are the result of one or more computing modes applied respectively to each of these images.

The relational descriptors may either be constructed explicitly ad-hoc or be the result of a computing mode applied to any image, distinct from the candidate and reference images. The relational descriptors in the ordered list of the relational repository may be of different natures and/or forms. The relational descriptors, whatever the case, are known before the method according to the invention is implemented.

The descriptors of the reference or candidate images are, for their part, the results from the one or more computing modes associated with the relational descriptors. In practice, the descriptors most similar to the relational descriptors of the relational repository are selected from these computing results. This selection leads to the identification, in the corresponding reference or candidate image, of a set of positions, referred to as “points of interest”, which correspond to the noteworthy points associated with the selected descriptors. Within the meaning of the invention, a given noteworthy or salient point of an image will therefore be called a “point of interest” of this image, for this image descriptor, when the one or more desired characteristics associated with the descriptor have a sufficient degree of similarity with the one or more characteristics associated with one of the relational descriptors. One and the same point of an image may potentially be detected multiple times as a point of interest for various descriptors in the course of implementing the method according to the invention. Thus, within the meaning of the invention, a descriptor of a reference image or of the candidate image constitutes a means of detecting points of interest in these respective images, which points of interest are not intended to represent the content of the image as a whole but to contribute—through the n-tuples formed by their coordinates—to correlating the candidate image under consideration with a reference image, via a relational repository. Where applicable, such detection of points of interest may be carried out on multiple scales, with various image resolutions, and in invariant fashion regardless of the pose of the camera, variations in illumination, or even capture noise during the acquisition of the image.

Thus, for any relational descriptor under consideration in the ordered list of the relational repository, a point of interest in the candidate image is detected by applying, in this image under consideration, the computing mode associated with such a relational descriptor, in order to determine descriptors of the candidate image that depend on the points of application of the computing mode in the image. In other words, for each constituent relational descriptor in the ordered list of the relational repository, applying the computing mode associated with this relational descriptor in an image makes it possible, on the one hand, to determine whether this image comprises at least one descriptor of this image that is local and robust and of a nature and a form similar to that of the relational descriptor and, on the other hand, to determine the position of this descriptor. Of course, it is entirely conceivable for the image to have multiple descriptors resulting from the computing mode associated with the relational descriptor, in which case multiple potential points of interest are detected.

When at least one descriptor results from the computing mode associated with the relational descriptor, this descriptor is said to be “transient”. The resemblance (or similarity) between the relational descriptor and each transient descriptor obtained computationally is then compared, generally computationally. To this end, the invention makes provision to determine a degree of similarity between the relational and transient descriptors. Preferably, the degree of similarity between the descriptors should be greater than or equal to a fixed minimum threshold such that the compared descriptors are considered to be similar. Only when the descriptors are similar is the point retained as a point of interest. Colloquially and for the sake of simplification, it is then said that the relational descriptor “is found” in the analyzed image, at the point of interest, or that the point of interest “is associated” with this relational descriptor, in the analyzed image. It is also possible for example to classify the transient descriptors in line with this degree of similarity and to retain several of them for one and the same relational descriptor, but provided that only those exhibiting a degree of similarity greater than a chosen threshold degree are retained.

For example, one possible mode for determining the degree of similarity between two descriptors is to measure a distance between the data structures representing each descriptor. In this case, the degree of similarity is the value of the measured distance, whereas the measurement of the degree of similarity corresponds to the nature of the chosen similarity computation, for example the computing of a Hamming distance, Mahalanobis distance, Levenshtein distance or else Hausdorff distance.

For example, if the relational descriptor is a descriptor of colorimetric nature describing a certain red gradient, the associated computing mode to be applied to the candidate image may be chosen as the RGB computing mode. If this computing method results in a transient descriptor that itself delivers a certain red gradient value, at at least one point of the image, then the actual red gradient values should be compared, for example by subtraction, and the result obtained should be compared with a fixed threshold value to determine whether the descriptors are similar.

In singular cases where some relational descriptors do not have any associated point of interest in a given image, given an excessively low degree of similarity between relational and transient descriptors (in line with a chosen threshold), or else given an excessively low degree of relevance of transient descriptors within an area of the chosen image, specific processing has to be applied in order to allow the candidate and/or reference lists to be constructed and compared, for example by decreeing a state specific to the rank in question of the list. Colloquially and for the sake of simplification, it is then said that the relational descriptor is not found in the analyzed image.

Thus, for each constituent relational descriptor in the ordered list of the relational repository, applying the corresponding measurement of the degree of similarity to real values between said relational descriptor and each of the transient descriptors computed in the image under consideration makes it possible to classify these transient descriptors with respect to one another in order to determine, if there are any, the one or more points of interest where the relational descriptor under consideration is found in accordance with the desired degree of similarity in the analyzed image.

The points of interest obtained for the candidate image and each reference image are then kept in lists called a “candidate” list or a “reference” list, respectively. In other words, each of the reference lists implemented in step b) and the candidate list determined in step c) are obtained using the relational descriptors of the relational repository. A new candidate list is generally generated each time a new candidate image is implemented within the meaning of the invention.

In practice, each of the reference lists and candidate list therefore comprises the coordinates, in the corresponding image, of the points of interest where each of the relational descriptors of the relational repository are found. If a relational descriptor in the ordered list is not found in at least one of the images, no point of interest is associated therewith in this image, meaning that no coordinates are associated therewith in the corresponding list. If, on the other hand, a relational descriptor is found at multiple points of interest in the image, the list will comprise each of the coordinates of these multiple points of interest. Preferably, the number of points of interest that may be associated with a given relational descriptor will be limited, for example to 1, 2, 3 or even more, as needed. It will then be the points of interest associated with the transient descriptors exhibiting the highest degree of similarity with the relational descriptor in question that will be kept in the list.

“Correlating” images or parts of images, according to the invention, is therefore understood to mean identifying, in each image or part of an image, positions of points of interest according to predefined local characteristics (which are given by the relational descriptors of each relational repository), and using descriptor computing modes, and measurements of degrees of similarity between descriptors, all forming each relational repository. It is therefore the relational repository (or the relational repositories and knowledge of the relationship for changing from one to another) that makes it possible to correlate the candidate list and each of the reference lists, and consequently to correlate the candidate image with each of the reference images. Within the meaning of the invention, the matching of images is thus a specific correlation of images. Within the meaning of the invention, it will be considered that the correlation of a candidate image with a reference image is therefore carried out at the end of determining the candidate list and comparing it with the reference list, on the basis of the relational descriptors in the ordered list of the relational repository.

Preferably, a candidate image is correlated with multiple reference images, successively or in parallel.

The list of the relational repository is “ordered”, in that the place (or rank) of each relational descriptor in the list is known. For example, it is possible to assign a number to each relational descriptor on the basis of its position in the list.

The order of each reference list and of the candidate list is established on the basis of the order of the list of relational descriptors of the relational repository. This means that, although the orders may be different between all of these lists, the relationship for changing from one order to another is known. One particular case that is preferred here is the case where the order of each reference list and of the candidate list is established in line with the order of the list of relational descriptors of the relational repository, that is to say that all of the orders are identical, rank by rank.

Thus, the order of the list of relational descriptors preferably remains unchanged for correlating the candidate image with the reference images. Using one and the same ordered list of relational descriptors to correlate two distinct images implicitly results, in each of the two lists, in one and the same order for the points of interest resulting from these images (which order is constrained directly or indirectly by said ordered list of relational descriptors). This identical, or at the very least known, order facilitates the correlation of the images by the possible pairing of homologous points of interest between said images, or else the determination of homologous clusters of data resulting from said images, as will be explained below. The order is considered to be “indirectly constrained” for example when two distinct but compatible relational repositories are used to analyze the candidate image and the reference image, such that the order associated with the reference list and the order associated with the candidate list may be different, but the relationship for changing from one order (that of the candidate list for example) to another (that of the reference list for example) is known. This relationship exists notably because the relational repositories are compatible with one another, as will become apparent from the description below. On the contrary, the order is “directly constrained” for example when one and the same relational repository is used to establish each candidate and reference list, or when two distinct and compatible relational repositories are used, but the difference between these relational repositories is not related to the order of the relational descriptors that they respectively contain.

Thus, by virtue of the method for correlating images according to the invention, determining the reference lists and the candidate list, constrained by the choice of relational descriptors that are ordered in the list of the relational repository, allows fast sequential pairing of homologous points of interest in these images.

### SUMMARY OF THE INVENTION

The present invention therefore proposes a novel approach to correlating points and digital images prior to any other subsequent processing operations carried out on the image. This novel approach improves the performance of existing methods used for image registration, object recognition and classification thereof among a large number of reference images.

The method according to the invention, notably by virtue of the relational repository, makes it possible both to correlate disparate images, which have no link between one another and which contain very different content, for example an image showing an item of jewelry with an image showing a landscape or a kitchen utensil, and to correlate more similar images, for example two models of products from one and the same brand.

The use of the relational repository allows the method of the invention to achieve high computing speeds while at the same time requiring fewer computing resources. The method according to the invention therefore makes it possible to perform a priori registration, recognition and classification tasks in real time, including using mobile terminals and on video streams.

The method according to the invention avoids the use of extreme computing methods (for example massive brute force, on a large quantity of data) by optimizing the resources according to the chosen implementation, for example by partially using part of the relational repository, in a first iteration, and then a following sequence using all or another part of said relational repository.

Preferably, the method according to the invention is implemented so as to decouple the computing of the reference lists and the computing of the candidate list. Preferably, the reference lists are in fact created before the method is implemented on the candidate image, according to another method of the invention, which is a method for creating a set of reference lists in accordance with the invention. In other words, preferably, the reference image has been analyzed from the perspective of the relational repository before the method according to the invention is implemented, such that the corresponding reference list is known before the method according to the invention is implemented and before the candidate image is analyzed. Thus, in step b) of the correlation method according to the invention, it is enough to call up the pre-established reference list, without having to call up the reference image itself. This makes it possible to limit the amount of information manipulated in real time by giving priority to the use of previously saved data, which here are essentially reference lists formed of n-tuples of coordinates of points of interest computed using the relational repository. This leads to an additional time saving when correlating the candidate image with this reference image, by allowing reduced computations at this time and a short response time.

The computations according to the invention are therefore faster compared to the computing times of already known methods. This advantage is further heightened when the method is implemented to analyze successive images coming from video sequences.

Other advantageous features of the correlation method according to the invention are described below.

The method according to the invention uses a relational repository that is chosen, preferably autonomously or in a manner optimized with regard to the reference images and the candidate images. This optimization may be carried out automatically or by humans, or even by combining both approaches (speed and precision for the automatic part, value of experience and meaning for the human part).

The relational repository is said to be “autonomous” when the ordered list of relational descriptors that it contains is chosen without prior analysis of the candidate image or each of the reference images. The autonomous relational repository makes it possible to decouple the correlation of two images from the respective content of these images. The relational repository is said to be an “indirect repository” when it predefines, without the need to know the reference and candidate images, the relational descriptors that will make it possible to identify and position the local characteristics associated with said relational descriptors.

The relational repository is said to be “optimized” when it is chosen in line with an appropriate ability to discriminate between the reference images and/or for a given or expected family of candidate images. The relational repository may thus easily be modified or optimized with regard to the population of reference images or even the type of candidate image to be considered. This optimization is possible since, according to the invention, the list of relational descriptors of the relational repository does not have the objective of giving a relevant description of the global information content of each image taken individually, but has the objective of locating characteristics defined a priori (upstream of the implementation of the method), in respectively optimized fashion, by each relational descriptor, that is to say of determining one or more corresponding points of interest and ultimately an ordered set of coordinates associated with these points of interest. The method according to the invention thus makes it easily possible to mix up the nature of the relational descriptors chosen a priori, and to adapt, to the usage case, the possibility of recognizing a candidate image or even of authenticating this image, the possibility of determining that a candidate image belongs to an image family and, by extension, the possibility of authenticating a tangible subject present in the image and/or of determining that this tangible subject belongs to a family or a category of tangible subjects, or even of sequentially carrying out these various tasks.

In particular, the relational repository may be optimized for a given task. It may be different if the envisaged task consists in registering the images with one another, recognizing images or tangible subjects appearing in the images, comparing or else classifying the images.

The relational descriptors of the relational repository may also be chosen in line with repeatability and stability criteria. When a repeatable relational repository is used multiple times to determine an ordered list based on an image, the resulting list is the same each time, for example. Similarly, when one and the same stable relational repository is used multiple times to determine an ordered list based on multiple different images having common points, certain similarities emerge from the lists that are obtained, for example.

In one embodiment, the relational repository is optimized by way of a learning process. This learning process may be of any appropriate nature, for example based on genetic algorithms or neural networks, in order to provide the expected performance in the usage case under consideration. This learning process may be implemented automatically, with or without human assistance.

According to one advantageous feature of the method according to the invention, the ordered list of relational descriptors of the relational repository is optimized on the basis of at least the reference lists implemented in step b), so that the coordinates of the respective points of interest associated with each relational descriptor are different from one reference image to another. In other words, the ordered list is optimized so as to keep only the relational descriptors that make it possible to discriminate the reference images from one another as well as possible, in that the relational descriptors are found at points of interest with different coordinates from one reference image to another.

According to another feature, the ordered list of relational descriptors of the relational repository is optimized on the basis of the reference lists implemented in step b), so that the distributions of the points of interest corresponding to each of the relational descriptors in the reference image are as far away as possible from one reference image to another.

According to another feature, the ordered list of relational descriptors is optimized on the basis of the reference lists implemented in step b), so that each point of interest associated with one of the relational descriptors in the reference image is locally distributed in each reference image. In practice, this means that the relational descriptors are each found at a single respective and distinct point of interest in the reference image.

According to one advantageous feature of the method according to the invention, the ordered list of relational descriptors of the relational repository is optimized on the basis of at least the reference lists implemented in step b), so that the points of interest within each reference image are distributed equally. “Distributed equally” is understood to mean that these points are distributed randomly and relatively uniformly in the various reference images.

Within the meaning of the invention, it is perfectly conceivable for a first relational repository to be used to establish a reference list based on a given reference image, and for another relational repository, different from the first, to be used to establish the candidate list based on the candidate image, provided that these relational repositories remain compatible with one another such that it is possible to change from one relational repository to another when the candidate image is correlated with the given reference image. It will be considered that two relational repositories are compatible with one another when they give rise to a similar list of points of interest, in line with a chosen similarity criterion (or a chosen measurement of degree of similarity), after having been respectively used with the same benchmark image. As explained above, in this case too, measuring the degree of similarity is tantamount for example to computing a distance (using a chosen computing mode) between the lists and to comparing the obtained value with a chosen threshold value. As a variant, it will also be considered that two relational repositories are compatible with one another when, on the one hand, the first relational repository is used to respectively determine a first and a second list of points of interest based on a first and second image, and the second repository is used to respectively determine a third and a fourth list of points of interest based on said first and second images and, on the other hand, there is a first relationship between the first and second lists of points of interest and there is a relationship similar to the first relationship between the third and fourth lists of points of interest, in line with a chosen similarity criterion. The relationship between lists may for example stem from a statistical analysis and/or a geometric analysis of the lists.

Two relational repositories implemented within the meaning of the invention (one to analyze the candidate image, the other to analyze a reference image) may, while being compatible with one other, for example differ in that:
1/ since the ordered list of relational descriptors is identical in both relational repositories, the computing mode and/or the measurement of the degree of similarity are distinct for at least one relational descriptor, the measurement of the degree of similarity remaining compatible with the computing mode and said relational descriptor; or,
2/ the ordered lists of relational descriptors used in each relational repository are of the same cardinal value and highly similar (without being identical) with regard to the relational descriptor data structures, term by term or taken as a whole; or,
3/ the ordered lists of relational descriptors used in each relational repository are of the same cardinal value but highly different term by term from the point of view of the relational descriptor data structures, the order and the ranks remaining compatible from one list to another; or,
4/ the ordered lists of relational descriptors used in each relational repository are of different cardinal values, but comprise a large number of common relational descriptors (that is to say identical ones here), and the rank of each relational descriptor is known in each relational repository.

Of course, all of the advantageous features described (above or below) with reference to the relational repository used to analyze the candidate image also apply to the one or more compatible relational repositories used to analyze the reference images.

It is also possible to envisage a different relational repository being used for each distinct image implemented in the method of the invention, be this a reference image or a candidate image, but provided that all of the relational repositories that are implemented are compatible with one another, that is to say that they have at least a common denominator allowing the method to be used.

For the sake of clarity in the description, the inventors wished to maintain the simplest general case of implementation, that is to say the one where one and the same relational repository is implemented for all of the images, but the reader is invited to keep in mind the possibility of implementing different relational repositories within the meaning of the above. Thus, according to one advantageous feature of the method according to the invention, it is conceivable for each reference list implemented in step b) to have been pre-established based on one and the same single relational repository, compatible with the relational repository implemented in step a) (used to establish the candidate list), but possibly different therefrom. On the other hand, according to another advantageous feature of the method according to the invention, it is conceivable for the relational repository implemented in step a) (used to establish the candidate list) to be identical to the relational repository used to establish each reference list (this is the case described below).

It should be noted that the relational repository may, in addition to the ordered list of relational descriptors and, for each relational descriptor, in addition to the chosen computing mode for the transient descriptors and their measurement of a degree of similarity, comprise additional data such as a maximum number (for example 1, 2 or 3, etc.) of points of interest where each relational descriptor may be found, in the candidate image, possibly in each reference image. More precisely, as has been explained, classifying the descriptors resulting from the computing mode associated with a given relational descriptor makes it possible to retain the coordinates of the m points associated with the one or more transient descriptors whose degrees of similarity with the relational descriptor in question are highest, in line with said measurement of a degree of similarity, these m points becoming de facto m “points of interest”. For any relational descriptor in the ordered list of the relational repository, m points of interest may thus be detected in the image within the meaning of the invention, m being, as a general rule, an integer greater than or equal to one. When the integer m is strictly greater than 1, it is conceivable for it to form part of the parameters of the relational repository that are associated with the relational descriptor of said relational repository.

The relational repository may also comprise the coordinates of certain points where it will be sought to apply the computing modes, in the candidate images and possibly in the reference images, in order to find which relational descriptor best describes this point.

The relational repository may also, in addition to the ordered list of relational descriptors and, for each relational descriptor, in addition to the chosen computing mode for the transient descriptors and their measurement of a degree of similarity, comprise any other type of additional data without changing the meaning of the invention.

Moreover, it is perfectly conceivable, at a given rank in the ordered list of relational descriptors of the relational repository, to consider not just one but multiple different computing modes associated with the relational descriptor of this rank. The computing mode applied to a candidate image and a reference image, and/or to various reference images, is thus not necessarily the same for one and the same given relational descriptor. When this is the case, the one or more images to which this computing mode is intended to be applied are indicated in an additional parameter within the relational repository.

According to another advantageous feature of the method according to the invention, the relational repository may comprise a classification of the relational descriptors, that is to say their grouping into categories so as to form subsets of relational descriptors describing at least one common characteristic. For example, the relational repository may group together the relational descriptors that will respectively describe characteristics of contours, color or else texture in the image.

In one embodiment, the relational repository is obtained by extracting information from one or more “repository images”, which may be synthetic or natural images.

In order for an image to be able to be selected as a repository image, it must have specific features in terms of information. The inventors have so far identified that an image containing a richness in terms of information (variety of local characteristics and at different scales), coupled with regionalization of textures or micro-textures, having varied contours and a certain entropy, is potentially a good candidate to become a repository image. It is then said that the ordered list of relational descriptors results from a “visually complex” repository image. In a visually complex image, pixels of neighboring tiles are decorrelated from one another and the distribution of the tiles is largely random while being rich in information, meaning that different descriptors may qualify each region of this image. One example of a type of natural image able to serve as a reference image is illustrated in the figures attached to this invention (an iguana in a foliage environment). On the other hand, one example of an image that is not ideal, or not suitable, for determining relational descriptors is a Perlin noise image. The repository image is distinct from the candidate image and each reference image.

It is also conceivable for the relational descriptors included in the ordered list of the relational repository to be distinct and different. In practice, this means that they are countable and that there are no two identical relational descriptors in the ordered list.

According to another advantageous feature of the method according to the invention, the relational descriptors included in the ordered list of the relational repository are vectors distributed equally among one another in the sense of a measurement of a defined degree of similarity. Such a construction may notably be achieved using a “k-nearest neighbors” method.

According to one advantageous feature of the invention, each reference list is preferably saved for later use. It may also be modified and optimized between two implementations with candidate images.

According to one advantageous feature of the method according to the invention, the candidate list may be saved for later processing or use. Notably, the processing in step f) may comprise recording the candidate list in a form able to be used for computerized or automatic manipulation, preferably in a form analogous to that of the corresponding reference list. Preferably, the reference list comprises a record of the coordinates of each point of interest in accordance with a determined coordinate system of the reference points of interest. The candidate list then comprises the record of the coordinates of the candidate points of interest in accordance with the same coordinate system. Among the coordinate systems, mention may be made, in the context of two-dimensional or three-dimensional spaces, notably of the Cartesian coordinate system and the polar or cylindrical coordinate system.

As a variant or in addition, the processing in step f) may comprise grouping together the candidate list and each reference list in a form able to be used by computerized or automatic processing, all determined based on one and the same ordered list of relational descriptors.

According to another feature of the method according to the invention, and in order to facilitate the remainder of the method, the candidate and reference lists are indexed on the ordered list of relational descriptors, that is to say these reference and candidate lists comprise a means of identifying the relational descriptor and/or the rank at which it is placed in the ordered list, so as to know which relational descriptor gave rise to the coordinates of the point of interest in question. Such a means of identification may for example be an indicator of the relational descriptor itself. As a variant, the means of identification may be the number that corresponds to the rank of the relational descriptor in the ordered list of the relational repository. As another variant, the means of identification may comprise ordering the reference and candidate lists in the same order as the ordered list of relational descriptors.

In step f), the processing of the candidate list may possibly comprise more sophisticated computerized or automatic operations, for example matching the candidate list with the reference list, registering the candidate image with respect to the reference image, classifying the images, computing relational signatures between the images for unitary recognition.

According to another feature of the invention, the processing in step f) comprises a step of determining the existence of homologous points of interest between the candidate list and each reference list. “Homologous points of interest” should be understood to mean points of interest associated respectively with a descriptor of the reference image and with a descriptor of the candidate image, both of which are similar to one and the same relational descriptor of the relational repository (when one and the same relational repository is used to analyze each reference image and the candidate image). “Similar”, as stated, is understood to mean that the degree of similarity between the descriptors is high, in line with a chosen similarity criterion. A candidate point of interest is thus homologous to a reference point of interest if the descriptors of these points are both similar to the same relational descriptor of the corresponding relational repository. In yet other words, two points are homologous (from one image to another) if they are described with degrees of similarity of the same order by the same relational descriptor. Two points of interest are thus homologous when, one coming from the candidate image, the other coming from the reference image, their transient descriptors have sufficient degrees of relevance and degrees of similarity of the same order with respect to the associated relational descriptor in the relational repository. Of course, two homologous points of interest do not necessarily have the same coordinates in the candidate image and the reference image.

When the relational repositories used to analyze each reference image and the candidate image are different but compatible, two points of interest may for example be considered to be homologous when they are positioned at the same rank or at the corresponding ranks in each of the lists.

In the event that there are homologous points of interest between the images, it is conceivable to group the coordinates of these homologous points of interest in the form of pairs. In the event that one and the same relational descriptor in the ordered list is associated with multiple points of interest in at least one of the images, it is conceivable to generate multiple pairs of coordinates for this relational descriptor, in order to cover all or some of the possible combinations of homologous points of interest. It should be noted that, in each pair of coordinates, one of the coordinates corresponds to the point of interest of the relational descriptor in the candidate image, while the other of the coordinates corresponds to the point of interest of the relational descriptor in the reference image.

The ordered nature of the list of relational descriptors included in the relational repository is advantageous for quickly identifying the relational descriptors that gave rise to homologous points of interest in the reference and candidate lists.

Each of the lists, candidate list or reference list, may be analyzed from a statistical viewpoint by analyzing the easily manipulable data (the coordinates) that they contain, or else from a geometric viewpoint by analyzing the points of interest.

Thus, according to yet another feature of the method according to the invention, the processing in step f) comprises, in addition to or as a substitute for the processing operations already described, a statistical analysis of the reference points of interest and of the candidate points of interest.

For example, the statistical analysis includes a statistical calculation between the coordinates within each candidate or reference list, and/or between candidate and reference lists.

The correlation of the images then comprises for example establishing a mathematical relationship between the coordinates of a point of interest in the candidate list and the coordinates of the homologous point of interest in the reference list, along with a statistical calculation on all mathematical relationships established for all homologous points of interest from one list to another. For example again, the statistical analysis may also comprise comparing the points of interest in one of the lists and the points of interest in the other list to see whether some descriptors in the ordered list do not give rise to any points of interest in the candidate list but give rise to at least one point of interest in the reference list or vice versa.

More precisely, according to this variant in which the processing in step f) comprises a statistical analysis, the points of interest are defined by coordinates with m components and the statistical analysis is carried out on sets each formed by the coordinates or groups of coordinates of one and the same rank of the points of interest. Thus, the coordinates of the list (or group of coordinates), placed at the same one or more ranks in the analyzed lists, are processed from a statistical point of view. This statistical processing gives rise to clusters of data in each of the candidate and reference lists. “Clusters of data” are understood to mean the result of the statistical analysis, in the form of data packets grouped in line with chosen criteria. For example, a cluster may group together points of interest on the basis of their geographical position in the candidate or reference image. Another example of a cluster may be the grouping of points of interest belonging to one and the same regional texture of an image. Another example of clusters is the set of descriptors having no point of interest in the candidate image and/or in the reference image.

Preferably, the sets (or clusters) each formed by the coordinates or groups of coordinates of one and the same rank of the candidate points of interest are classified in line with a similarity criterion with respect to the sets each formed by the coordinates or groups of coordinates of one and the same rank of the reference points of interest. This classification makes it possible to evaluate the resemblance between the candidate image and the reference image. The resemblance between the images encompasses the resemblance between the lists and the resemblance between tangible subjects represented in the images.

This embodiment according to which the processing in step f) comprises a statistical analysis is particularly advantageous when the candidate image and the reference image are images taken at one and the same viewing angle and with a similar magnification, for example with the aid of a crosshair. It is then said that the images are pseudo-registered or pre-registered, and they are able to be correlated effectively through statistical analysis. A more precise example of this embodiment consists in computing the distance between the point of interest associated with a relational descriptor in the reference image and the point of interest associated with this same relational descriptor in the candidate image, that is to say in computing the distance between the coordinates of two homologous points of interest.

According to another advantageous feature of the method according to the invention, the processing in step f) comprises, in addition to or as a substitute for the processing operations already described, a geometric analysis comprising matching the candidate points of interest in the candidate list with the homologous reference points of interest in each reference list. In the case where, for one and the same relational descriptor, multiple coordinates of points of interest are associated in a list, respectively candidate or reference list, it may be advantageous to determine, from among all possible combinations, the one with the best match.

According to this variant of the processing in step f), the matching is followed by determining at least one geometric transformation associating the coordinates defining the points of interest in the candidate list with the coordinates defining the homologous points of interest in each reference list.

According to this variant, the matching comprises determining at least one geometric transformation associating the coordinates of the points of interest in the candidate list with the coordinates of the homologous points of interest in one of the reference lists. This operation may be repeated with each pair of homologous points of interest between the candidate list and one of the reference lists, and it is thus possible to determine multiple geometric transformations in an attempt to align the candidate image with this reference image and compare them in order to determine the best one of them. This operation may also be repeated with each of the reference lists, and it is thus possible to determine multiple geometric transformations in an attempt to align the candidate image respectively with each of the reference images and compare them in order to determine the best one of them.

These geometric transformations may be classified in line with one or more predetermined quality criteria so as to choose the best one for correlating the candidate image and this reference image.

The quality criteria for determining whether a geometric transformation is better than the others are for example as follows: the least squares error between transformed image and target image (for example respectively candidate image and reference image), the number of mutually homologous points of interest, the sending of at least a given number of points of interest of the candidate image to an area, of determined surface area (as small as possible) around the homologous points of interest of the reference image. For example, a point in a small area is sought, but it is possible to allow a certain tolerance radius around the theoretical homologous point of interest (in the reference image) that it is sought to match with the homologous point of interest (of the candidate image). In practice, for example, it may be considered that the greater the number of matching homologous points of interest, each within the smallest possible tolerance radius around their respective homologous point of interest, the higher the quality criterion.

The sought geometric transformation may for example take the form of a rigid transformation (translation and/or rotation and/or change of scale), a homography or any other (rigid or non-rigid) point-to-point geometric transformation.

It is also conceivable for there to be no geometric transformation between the candidate image and the reference image, in which case these two images will be considered to be too far apart from one another to be able to be registered or compared, meaning that the only benefit of correlating them will be that of affirming that they have no link to one another.

The embodiment according to which the processing in step f) comprises a geometric analysis is not incompatible with the previous embodiment according to which the processing comprises a statistical analysis. Geometric analysis is preferable when the reference image and the candidate image are not pseudo-registered, that is to say they were taken without any precaution, namely the candidate image was taken without trying to reproduce the capturing of the one or more reference images.

Of course, there are as many geometric transformations to be determined as there are reference images with which it is desired to correlate the candidate image. These geometric transformations may also be classified in line with a pre-established quality criterion so as to choose which of the geometric transformations is best.

In other words, one of the reference images gives access to the most promising geometric transformation for correlating the candidate image with respect to this reference image, for example for its future registration or the future recognition of a tangible subject present in the candidate image.

According to one advantageous feature of the method according to the invention, each geometric transformation sought in step f) is a direct geometric transformation between the candidate list and each reference list.

What is thus sought is the geometric transformation that makes it possible to place the coordinates of one of the points of interest in the candidate list on or as close as possible to the coordinates of the homologous point of interest in each reference list, and to do so for a maximum number of homologous points of interest. In other words, the geometric transformation must match the coordinates within each pair of homologous points of interest as well as possible.

According to another possible feature of the method according to the invention, each geometric transformation sought is an indirect geometric transformation between the candidate list and the reference list. Such an indirect geometric transformation is the result of a succession of geometric transformations between the coordinates in the candidate list and the coordinates in the reference list, via at least one intermediate list containing the coordinates, in any intermediate image, different from the candidate image and from each reference image, of positions of descriptors of this intermediate image that are determined in line with the computing mode of the relational repository and similar to the relational descriptors.

In a simplified manner, an indirect geometric transformation comprises:

a first direct geometric transformation between the candidate list and the intermediate list, which intermediate list comprises the coordinates, in the intermediate image, of any points of interest associated with the relational descriptors in the ordered list of the relational repository, and

a second direct geometric transformation between the reference list and the intermediate list.

According to one advantageous feature of the method according to the invention, provision is made to apply the best geometric transformation to the candidate image in order to register the candidate image with respect to the reference image. In other words, applying the best geometric transformation makes it possible to register this candidate image with respect to the reference image associated with this best geometric transformation.

Registration is a technique based on the matching of images or parts of images, or information extracted from these images, making it possible to compare, superimpose or even combine the respective information contained in these images, parts of images or information extracted from these images.

According to another advantageous feature of the method according to the invention, provision is made to implement a step of determining that the candidate image belongs to a predetermined class. This step generally follows the processing, which comprises determining a geometric transformation that makes it possible to change from the candidate image to the reference image, or else, alternatively, generally follows a statistical analysis step.

The membership class is represented respectively by the reference list, or the reference image, or the tangible subject represented in the reference image, that is closest within the meaning of a chosen membership criterion. A membership class is thus defined by various characteristics of the class. It is the similarity with each or all of these characteristics, referred to as “membership criterion” here, that determines membership in the class. Thus, checking the criterion of membership in a class may consist for example in evaluating the distance, with respect to the chosen characteristic, between the candidate list and each reference list. For example, the membership criterion may be considered to be validated for the one or more shortest distances for reaching the reference list from the candidate list. This inter-list distance may be used in conjunction with a defined acceptance threshold. This is tantamount to comparing the evaluated distance with a defined acceptance threshold. Above the acceptance threshold, the candidate list does not belong to the membership class corresponding to the reference list, and below it, it belongs to this class.

It is entirely conceivable for the candidate list (or the candidate image or the tangible subject represented in the candidate image) not to belong to any predefined class.

“Class” is understood to mean a set of characteristic properties of a reference list, or of a reference image, or else of a tangible subject represented in the reference image. A class may contain one or more elements (for example the class of a specific product identified by its unit serial number (1 individual element), the class of the series products of one and the same model (a large number of constituent elements), the class of the products of one and the same brand, the class of the constituent components of an assembled product, etc.). A class containing just a single member may be implemented for authentication. Reference will then be made to a unitary class. A class may be named, and/or associated with a person or an organization (for example the class of tangible subjects belonging to a date defined by a person or organization), or with even another class. A class may be reconfigurable, and depend on the choice of relational repository. The characteristic properties of the class may of course be more or less specific. A class may itself be divided into subclasses that are or are not disjoint, included in the class such that each subclass contains only some of the elements of the class. Each class may thus be a more or less extensive set, and include various subclasses. The class may be reconfigurable over time, in which case the reconfigured class is considered to be a new class, although it may possibly have identical characteristics, notably an identical name.

According to one advantageous feature of the method according to the invention, it is conceivable for at least some of the reference images to be constructed images representative of at least two distinct tangible subjects belonging to one and the same class of tangible subjects.

A constructed image stems for example from the superposition, after registration for example, of two images representing two tangible subjects of one and the same class, and from the elimination of the distinct parts so as to keep only parts common to these two images. Using a constructed image representative of multiple distinct subjects belonging to the same class makes it possible to eliminate the specific characteristics of each subject, so as to keep only traits common to all subjects. In other words, the constructed reference image that is used makes it possible to smooth the noise that exists in each image of a singular subject. According to one advantageous feature of the method according to the invention, it is also conceivable for at least some of the reference images to be constructed images representative of at least two distinct tangible subjects belonging to distinct classes of tangible subjects.

Thus, when each reference image is respectively representative of a class of tangible subjects, it is conceivable to use the processing of the candidate list or of the candidate image to classify the membership of a candidate subject represented in the candidate image in the class of tangible subjects that is represented by the corresponding reference image.

In practice, a score may be established for each geometric transformation, making it possible to change from the candidate image to one of the reference images, on the basis of pre-established criteria. The score that is obtained gives a first idea of the resemblance between the reference image and the candidate image. The resemblance between the images encompasses the resemblance between the lists and/or the resemblance between tangible subjects represented in the images.

According to another advantageous feature of the method according to the invention, a step of unitary recognition of the candidate image may be implemented.

Preferably, this unitary recognition step follows the registration step. It is conceivable notably for the unitary recognition step following the registration to comprise a method for determining a relational fingerprint between the two candidate and reference images, as described in document WO2017198950.

As a variant, it is also conceivable for the unitary recognition step following the registration to comprise a step of subtracting points between the registered candidate image and each reference image.

As a variant, and according to one advantageous feature of the method according to the invention, the step of unitary recognition of the candidate image comprises iterating steps a) to f) with other reference images and/or another relational repository comprising another ordered list of relational descriptors and/or other computing modes and/or other modes for determining the degree of similarity.

Thus, after having established a first class link between the candidate image and the reference image, it is possible to specify the subclass to which the tangible subject represented in the candidate image belongs, by reiterating steps a) and f) of the method, according to the various advantageous features described above. This iteration is performed by taking other reference images and/or another relational repository. This iteration makes it possible to refine the recognition of the tangible subject represented in the candidate image in order ultimately to achieve unitary recognition of the tangible subject.

According to one advantageous feature of the method according to the invention, it is conceivable for each iteration of steps a) to f) to be implemented on a region of interest of the candidate image that has a reduced surface area compared to the total surface area of the initially correlated part of the candidate image.

This feature makes it possible to focus on certain potential details of the tangible subject represented in the candidate image, once a first registration has been implemented.

The invention also relates to the use of the described correlation method to recognize various elements on a path with a view to establishing a digital collection of digital content, said reference images being chosen on the basis of the elements to be recognized on the path.

More precisely, according to this use, the membership class (unitary or not) of various elements is recognized successively: tangible subjects or parts of one and the same tangible subject. The various elements that are recognized may for example be each face of a packaging box, each constituent element of a watch. In this use of the method, the reference images are then chosen on the basis of the desired membership classes. According to this use of the method, it is thus possible to follow the path of the user (in the sense of temporality and/or surrounding space). The path may, by choice, be imposed, this meaning that it is necessary to first recognize a given element before being able to recognize another element, or be free, this meaning that it is possible to recognize the various elements in any order, over the whole of the path or only part, or even that at least one element may be recognized multiple times.

According to this use, each recognized element is associated with chosen digital content, either related directly to the object or not related thereto. For example, the digital content may comprise the owner of the element, and/or a message intended for the user who has recognized the element, and/or a cryptographic token able to be used in computerized processes such as blockchain processes.

The various elements recognized along the path thus lead to a collection that may be associated either with the pre-established digital content listed above or with the digital collection of the elements themselves. The data forming part of the collection are for example: the tangible subject or the part of the recognized tangible subject, the membership class of this subject, the digital content associated with this subject, the cryptographic token associated with this subject, etc.

According to one preferred use, the successive recognition of each element may trigger access to the (static or dynamic) digital content associated with each element, and all of the digital content encountered on a path may be combined into a collection of digital content. This collection of digital content may advantageously be managed by way of cryptographic tokens saved in a blockchain, known as non-fungible tokens (NFT). This particular implementation makes it possible to reliably and securely manage the ownership of the collections and, consequently, of the constituent elements of these collections. This implementation also makes it possible to track transfers of ownership automatically and securely.

According to one advantageous feature of this use, provision is made, prior to the recognition of the elements, to record the digital content that is associated with each element in a memory.

According to another advantageous feature of this use, provision is made, after the recognition of the elements, to record the accessing and/or the transfer of ownership of the element, and/or the creation of a cryptographic token, and/or the accessing of a cryptographic token associated with the element in a memory or a register (such as a blockchain).

According to another advantageous feature of this use, provision is made for a step of recognizing the user and/or the device used to generate the candidate image, prior to the recognition of the elements.

The invention also relates to a method for creating a reference list, comprising the following steps:

implementing a relational repository comprising at least: an ordered list of relational descriptors, at least one computing mode to be applied to the reference image in order to determine descriptors of this image, and a mode for determining the degree of similarity between two descriptors, and

determining descriptors of the reference image, computed in line with each descriptor computing mode of the relational repository, and determining the position of each of these descriptors in the reference image,

determining the degree of similarity, determined in line with the determination mode of the relational repository, between each descriptor of the reference image and each relational descriptor of the relational repository,

determining a reference list comprising the positions, referred to as reference points of interest, in the reference image, of each descriptor of the reference image exhibiting the greatest similarity with the corresponding relational descriptor and that is ordered on the basis of the order of the relational repository.

This method makes it possible to establish at least one reference list, preferably a bank of reference lists, prior to the implementation of the correlation method according to the invention, thereby generating a considerable time saving when implementing the method for correlating with a candidate image.

This method is highly similar to steps c) to e) of the correlation method according to the invention, except that a reference image is used instead of the candidate image, and that the relational repository that is used is not necessarily identical to the relational repository used to establish the candidate image, provided that it is compatible with the one used to establish the candidate list. That being said, the relational repositories are preferably identical.

According to one advantageous feature of this creation method, a set of reference lists is created by iterating the determination steps, based on the implementation of mutually compatible relational repositories, preferably based on one and the same single relational repository.

This method may advantageously be implemented in distributed computing mode via what is known as a “cloud” environment for performing computations and comparisons with reference lists, the latter advantageously also being able to be stored in this same cloud. This method may advantageously use smartphones to connect to this environment and transmit the candidate images or the result of computations carried out on these candidate images. Likewise, this method may broadly use blockchains in order to strengthen the security of the digital data employed.

Of course, the various features, variants and embodiments of each method according to the invention may be associated with one another in various combinations, provided they are not incompatible or mutually exclusive.

### BRIEF DESCRIPTION OF THE DRAWINGS

Moreover, various other features of the invention will become apparent from the appended description given with reference to the drawings, which illustrate non-limiting embodiments of the invention and in which:

FIG. 1 is a schematic depiction of a relational repository used in the correlation method according to the invention,

FIG. 2 is a schematic depiction of certain steps of the correlation method according to the invention,

FIG. 3 is a schematic depiction of one exemplary correlation (step f) of the correlation method according to the invention,

FIG. 4 is a schematic depiction of another exemplary correlation (step f) of the correlation method according to the invention, and

FIG. 5 is an image-based representation of the correlation method and of the correlation method according to the invention.

It should be noted that, in these figures, structural and/or functional elements common to the various variants or examples bear the same references.

### DETAILED DESCRIPTION

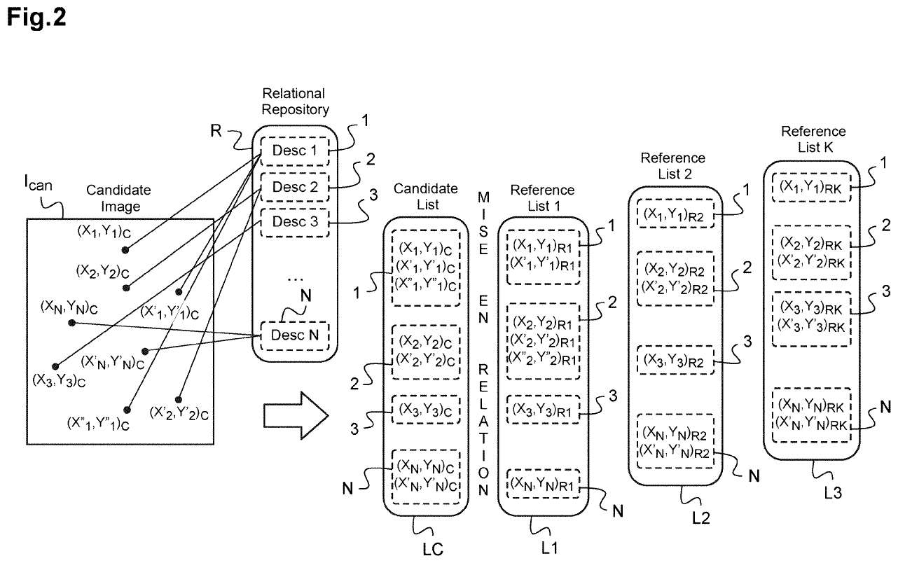

FIG. 2 shows the main steps of a method for correlating at least part of a candidate image Ican with at least one reference image, in accordance with the invention.

According to this method, provision is made to carry out the following steps:
a) implementing a relational repository comprising at least: an ordered list of relational descriptors, at least one computing mode to be applied to the image in order to determine descriptors of this image, and a mode for determining the degree of similarity between two descriptors,
b) implementing, for each reference image, a reference list that comprises the positions, referred to as reference points of interest, in the reference image, of descriptors of the reference image that are similar to relational descriptors from a relational repository compatible with the relational repository implemented in step a), which reference list is ordered on the basis of the order of this compatible relational repository,
c) determining, in the candidate image, descriptors of the candidate image that are computed in line with each descriptor computing mode of the relational repository implemented in step a), and determining the position of each of these descriptors in the candidate image,
d) determining the degree of similarity, determined in line with the determination mode of the relational repository implemented in step a), between each descriptor of the candidate image and each relational descriptor of this relational repository,
e) determining a candidate list that comprises the positions, referred to as candidate points of interest, in the candidate image, of the descriptors of the candidate image exhibiting the greatest similarity with the relational descriptors of the relational repository implemented in step a), which candidate list is ordered on the basis of the order of this relational repository, and
f) processing the candidate list with respect to each reference list on the basis of the order of the candidate and reference lists.

This correlation method is carried out using a computer medium such as a processor.

As shown in FIG. 2, provision is therefore first made to implement a pre-established relational repository R (step a).

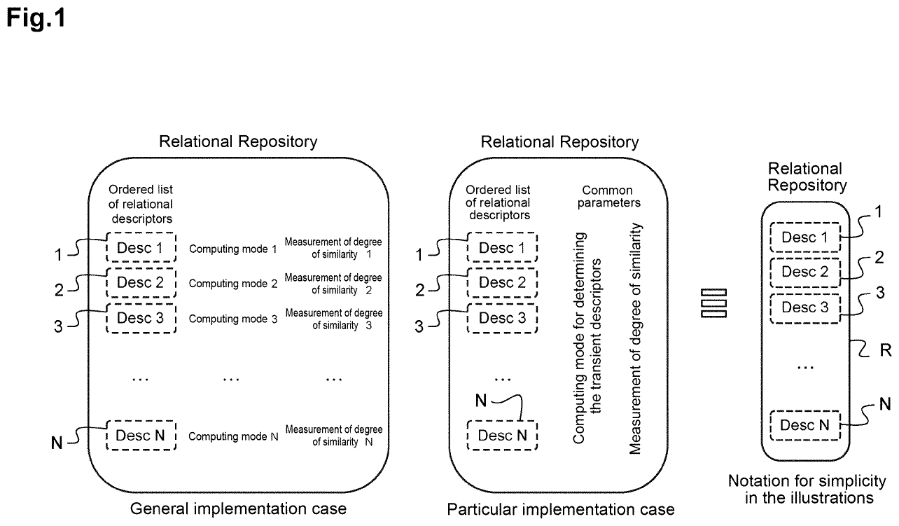

This relational repository R is illustrated in FIG. 1. It comprises an ordered list of relational descriptors Desc 1, Desc 2, Desc 3, . . . , Desc N, along with a computing mode and a mode for determining the degree of similarity that are associated with each of these relational descriptors. The order is given by the references 1, 2, 3, . . . , N and represented by the dashed frames in FIG. 1.

The computing mode associated with a relational descriptor is intended to be applied to an image and results in a local descriptor of this image that describes relevant predefined characteristics of the image that are located at one or more salient points of the image. This local descriptor is called a “transient descriptor” of the image.

The mode for determining the degree of similarity between two descriptors makes it possible to compare the similarity between the relational descriptor and the transient descriptor resulting from the computing mode associated with this relational descriptor. The degree of similarity is greater the more similar the compared descriptors. For example, one possible mode for determining the degree of similarity is measurement of a distance, such as a Hamming distance, Mahalanobis distance, Levenshtein distance or else Hausdorff distance, in line with the chosen similarity criterion. In other words, the degree of similarity is the value of the measured distance, whereas the similarity criterion is the nature of the chosen similarity computation (for example computing of a Hamming distance, Mahalanobis distance, Levenshtein distance or Hausdorff distance).

Preferably, it will be considered that the compared relational and transient descriptors are similar if the degree of similarity obtained by the determination mode is greater than or equal to a fixed minimum threshold.

In general, it will be considered that the computing mode associated with a relational descriptor may be identical or different from one relational descriptor to another and that the mode for determining the degree of similarity between two descriptors may itself also be identical or different from one relational descriptor to another. Thus, in the relational repository R, there may be at most as many computing modes and modes for determining the degree of similarity as there are relational descriptors.

In one particular case, not shown, the same computing mode associated with all of the relational descriptors is used, and the same mode for determining the degree of similarity is used. In this particular case, there is a single computing mode and a single mode for determining the degree of similarity.

As shown in FIG. 2, provision is then made to use the relational repository R illustrated in FIG. 1 with a view to determining a list, called candidate list Lc, listing the positions, here in the form of coordinates, of points of interest where the relational descriptors are found, in a candidate image Ican that it is desired to analyze (steps c to e).

The candidate image Ican is for example a photograph taken using a cell phone camera. This image is for example recorded in a memory.

More precisely, in step c), the descriptors of the candidate image are determined. To this end, the computing modes of the relational repository are applied to the candidate image, so as to determine the descriptors of the candidate image, called “transient descriptors” at this stage. In this same step, the position of the transient descriptors in the candidate image is also determined, these positions being for example obtained through the same computation as that employed to determine the transient descriptors.

In step d), the degree of similarity between each transient descriptor found and the relational descriptor associated with the computing mode used (when each relational descriptor is associated with its own relational descriptor), or with each transient descriptor found and each relational descriptor of the relational repository (when using a single computing mode for all relational descriptors), is then estimated. Preferably, in this step, the transient descriptors are classified on the basis of their degree of similarity with each relational descriptor taken individually, in order to be able to find the one or more most similar transient descriptors to be kept for each relational descriptor.

When two transient and relational descriptors are considered to be similar, the salient point of the analyzed image where the transient descriptor is located is retained as a point of interest of this image, for this relational descriptor. It is then considered that the relational descriptor “is found” in the analyzed image, at the point of interest. As shown in FIG. 2, it is entirely conceivable to find at least one of the relational descriptors at multiple distinct points of interest of the candidate image Ican. For example, the first relational descriptor Desc1 of the relational repository R is found at three distinct points of interest of the candidate image Ican: (x₁, y₁)_{c}, (x′₁, y′₁)_{c} and (x″₁, y″₁)_{c}; the second relational descriptor Desc2 is found at two distinct points of interest of the candidate image Ican: (x₂, y₂)_{c} and (x′₂, y′₂)_{c}; the third relational descriptor Desc3 is found at a single point of interest of the candidate image Ican (x₃, y₃)_{c}; and the n-th relational descriptor DescN is found at two distinct points of interest of the candidate image Ican: (x_{N}, y_{N})_{c} and (x′_{N}, y′_{N})_{c}.

In step e), the position of each point of interest, that is to say here the coordinates of each point of interest, is incorporated into the candidate list Lc. This incorporation is carried out on the basis of the order of the relational descriptors given in the ordered list of the relational repository R, that is to say the relationship between the order of the candidate list Lc and the order of the list of relational descriptors is known. In particular, here, the candidate list is ordered in the order of the list of relational descriptors, that is to say complying with the order of the relational descriptors given in the ordered list of the relational repository R. This order is symbolized by the dashed frames in the candidate list and in the ordered list.

As shown in FIG. 2, provision is then made to correlate the candidate list Lc obtained for the candidate image Ican with at least one reference list L1, L2, L3.

Preferably, each reference list L1, L2, L3 is obtained from a reference image Iréf1, Iréf2, . . . Iréfk, according to the same principle as that described above for obtaining the candidate list Lc, except that the relational repository that is used may be different from the one used to obtain the candidate list Lc, provided that it remains compatible with the relational repository used to establish the candidate list Lc. Here, for the sake of simplification, it will be considered that the relational repository used to establish the reference lists L1, L2, L3 and the candidate list Lc are identical.

The reference lists L1, L2, L3 are preferably obtained before the correlation method according to the invention is implemented. Thus, it is sufficient to call on (or implement) the pre-established reference lists L1, L2, L3 in the correlation method according to the invention (step b).

More precisely, in order to establish each reference list L1, L2, L3, a method for creating a reference list from a reference image Réf1, Iréf2, . . . Iréfk, in accordance with the invention, is implemented.

According to this creation method, the following steps are carried out:

implementing a relational repository comprising at least: an ordered list of relational descriptors Desc1′, Desc2′, Desc3′, . . . , DescN′, at least one computing mode to be applied to the reference image in order to determine descriptors of this image, and a mode for determining the degree of similarity between two descriptors, and

determining descriptors of the reference image, computed in line with each descriptor computing mode of the relational repository, and determining the position of each of these descriptors in the reference image,

determining the degree of similarity, determined in line with the determination mode of the relational repository, between each descriptor of the reference image and each relational descriptor Desc1′, Desc2′, Desc3′, . . . , DescN′ of the relational repository,

determining a reference list comprising the positions, referred to as reference points of interest, in the reference image, of each descriptor of the reference image exhibiting the greatest similarity with the corresponding relational descriptor Desc1′, Desc2′, Desc3′, . . . , DescN′ and that is ordered on the basis of the order of the relational repository.

In this creation method, the relational repository R that is used is the same as the one used in the correlation method, such that the list of descriptors Desc1′, Desc2′, Desc3′, . . . , DescN′ is identical here to the list of descriptors Desc1, Desc2, Desc3, . . . , DescN.

It will be considered that the reference list is ordered on the basis of the order of the relational descriptors of the relational repository, since the relationship between the order of the reference list and the order of the list of relational descriptors is known. One particular case implemented here consists in considering that the order of the reference list is identical to the order of the relational descriptors, that is to say that the reference list is ordered on the basis of the order of the list of relational descriptors.

The reference images that are used are for example (and preferably) obtained from an action similar to that used to obtain the candidate image Ican, namely here from a camera.

Once the reference lists L1, L2, . . . Lk have been obtained, they are therefore implemented in step b) of the correlation method according to the invention.

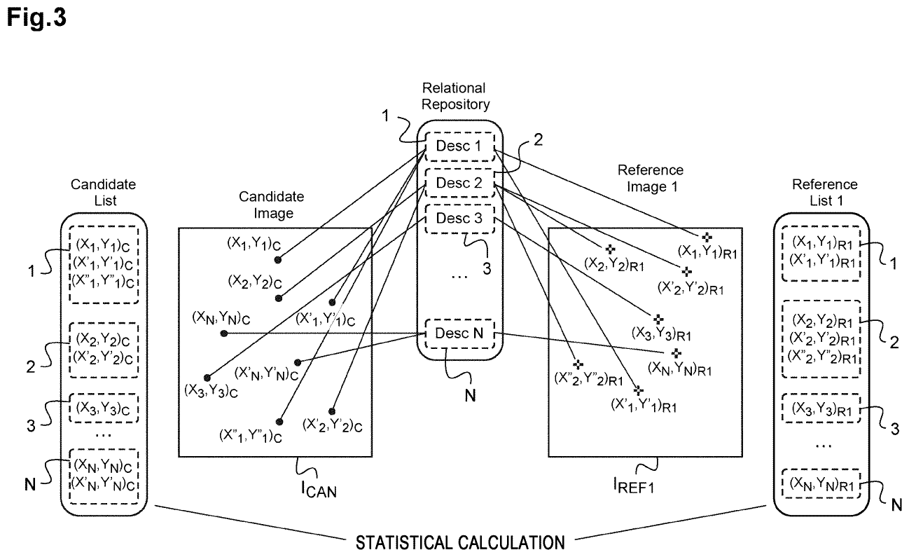

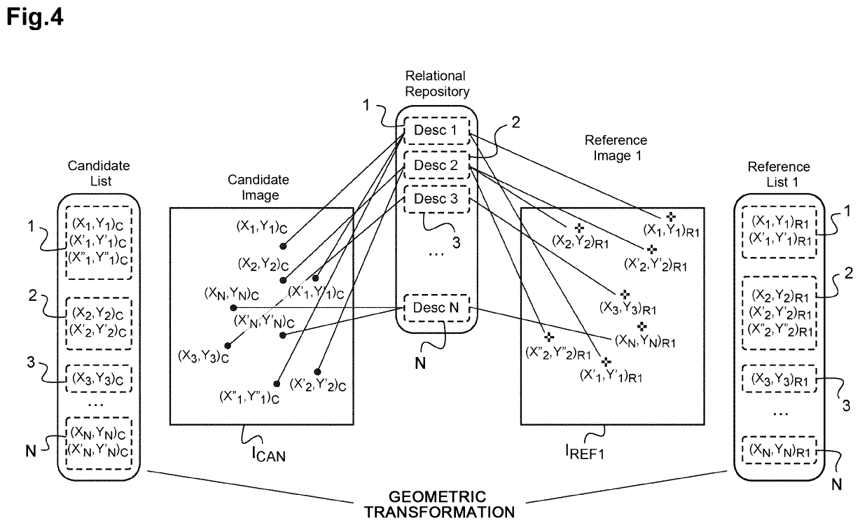

FIGS. 3 and 4 illustrate two different examples of correlation between the candidate list Lc and reference lists L1, L2, L3, namely one correlation using statistical calculation and another correlation by determining a geometric transformation.

Whether for one or the other exemplary correlation, it is preferable to start by identifying the homologous points of interest between the candidate list and each of the reference lists. In practice, the homologous points of interest are easily identifiable in the lists, since these lists are ordered on the basis of the order of the list of relational descriptors of the relational repository. The homologous points of interest are therefore represented by the coordinates located at the same rank in the respective lists. Thus, all of the coordinates placed at rank 1, that is to say those where the relational descriptor Desc1 is found, are the coordinates of homologous points of interest within the meaning of the invention, and the same applies to the coordinates placed at the one or more following ranks 2, 3 and N. Identifying the homologous points of interest is therefore tantamount in some ways to matching the dashed frames located at the same rank in the candidate list and in the reference list, it being understood that, when no point of interest has been associated, in the candidate image Ican (respectively in at least one of the reference images Iréf1, Iréf2, . . . , Iréfk), with one of the relational descriptors in the ordered list, the candidate list (respectively at least one of the reference lists) comprises a rank that is left empty.

The statistical calculation (illustrated in FIG. 3) makes it possible to analyze and compare the coordinates of the homologous points recorded in the candidate list with those recorded in the reference list, rank by rank.

The geometric transformation (illustrated in FIG. 4) attempts to reposition each point of interest in the candidate list on a homologous point of interest in the reference list. For example, the geometric transformation may take the form of a homography, but this is not the only conceivable geometric transformation. The geometric transformation may notably comprise a translation and/or a rotation and/or a change of scale.

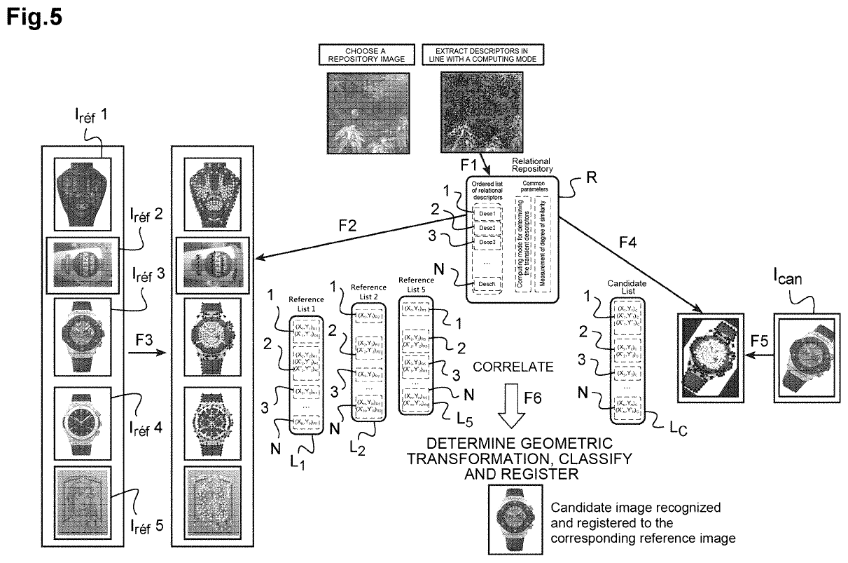

FIG. 5 illustrates the methods for correlating and creating reference lists in accordance with the invention.

In this illustration, the relational repository R is obtained from a complex repository image, from which the relational descriptors Desc1, Desc2, Desc3, . . . , DescN are extracted. More particularly, a chosen computing mode, here the Accelerated KAZE (or A-Kaze) mode, is applied to the repository image (arrow F1 in FIG. 5), and results in the relational descriptors that describe the repository image in relevant fashion. The repository image here depicts an iguana in a foliage environment. This repository image is visually complex insofar as the pixels of neighboring tiles are decorrelated from one another and the distribution of the tiles is largely random while being rich in information, meaning that different relational descriptors qualify each region of this image.

The computing mode included in the relational repository here is the same as the computing mode used to determine the relational descriptors from the repository image.

According to one variant, not shown, it is entirely conceivable to construct the relational descriptors of the relational repository from scratch, without extracting said relational descriptors from a repository image.

Once the relational repository R has been established, the method for creating the reference lists L1, L2, . . . , L5 is implemented (arrow F2 in FIG. 5). In this example, the creation method is implemented based on the 5 reference images Iréf1, Iréf2, Iréf3, Iréf4, Iréf5, to which the computing mode of the relational repository is applied (arrow F2). The reference images each represent a class of tangible subjects. More particularly, the first reference image Iréf1 represents a first watch model, the second reference image Iréf2 represents the class of disposable cups, the third reference image Iréf3 represents a second watch model, the fourth reference image Iréf4 represents a third watch model, and the fifth reference image Iréf5 represents a class of postage stamps.

Applying the computing method makes it possible to determine the coordinates of the points of interest where each relational descriptor Desc1, Desc2, Desc3, . . . DescN is found in each reference image Iréf1, Iréf2, Iréf3, Iréf4, Iréf5. The points of interest are represented by blue dots in the processed reference images.

The coordinates of the points of interest of the respective reference images Iréf1, Iréf2, Iréf3, Iréf4, Iréf5 are then recorded in respective reference lists L1, L2, . . . , L5. In the reference lists, the order (1, 2, 3, . . . , N) of the ordered list of relational descriptors Desc1, Desc2, Desc3, DescN of the relational repository R is complied with.

The correlation method is then implemented (arrow F4). In particular, a candidate image Ican is captured or retrieved. The computing mode of the relational repository R (arrow F5) is then applied to this candidate image Ican in order to extract therefrom the points of interest where the relational descriptors of the relational repository are found. This is tantamount to carrying out steps c) to e), described above, of the correlation method.

The coordinates of the points of interest of the candidate image Ican are then recorded in a candidate list Lc. In the candidate list Lc, the order (1, 2, 3, . . . , N) of the ordered list of relational descriptors Desc1, Desc2, Desc3, DescN of the relational repository R is complied with. The candidate list Lc is recorded in a form able to be used for computerized or automatic manipulation, preferably in a form analogous to that of the reference lists L1, L2, . . . , L5.

Finally, the candidate list Lc is correlated with each reference list L1, L2, . . . , L5 (arrow F6). Here, the correlation consists in pairing the points of interest in the candidate list Lc with the homologous points of interest in each reference list L1, L2, . . . , L5, and then in determining the best geometric transformation for matching the homologous points of interest.

Here, the best geometric transformation is a rotation and scaling of the candidate image Ican. Determining this best geometric transformation then makes it possible to determine that the candidate image Ican belongs to one of the classes represented by the reference images Iréf1, Iréf2, Iréf3, Iréf4, Iréf5. In this case, the candidate image belongs to the class represented by the third reference image Iréf3. Applying the geometric transformation makes it possible to register the candidate image Ican to the reference image Iréf3.

It is entirely conceivable then to iterate the correlation and creation methods according to the invention, with other reference images and/or another relational repository.

Thus, after having established a first class link between the candidate image Ican and the third reference image Iréf3, it is possible to specify the subclass to which the tangible subject represented in the candidate image Ican belongs, by reiterating, on the one hand, the method for creating reference lists in order to establish new lists from new images belonging to the class represented by the third image, and representing subclasses of this class and, on the other hand, the correlation method according to the invention. This iteration is carried out here by taking the same relational repository R, but it would be entirely conceivable to change it as well. This iteration makes it possible to refine the recognition of the tangible subject represented in the candidate image. Further iterating the methods according to the invention thus leads to unitary recognition of the tangible subject.

Although not shown, it is entirely conceivable for the iteration to be implemented on a region of interest of the candidate image Ican that has a reduced surface area compared to the total surface area of the initially correlated part of the candidate image.

Although not shown either, it is advantageous to use the correlation method according to the invention to recognize various tangible subjects on a pre-established path with a view to establishing a digital collection of objects, said reference images being chosen on the basis of said pre-established path.

1. A method for correlating at least part of a candidate image (Ican) with at least one reference image (Iréf1, Iréf2, Iréf3, Iréf4, Iréf5, . . . , Iréfk), comprising the following steps:
a) implementing a relational repository (R) comprising at least: an ordered list of relational descriptors (Desc1, Desc2, Desc3, . . . , DescN), at least one computing mode to be applied to the candidate image in order to determine descriptors of this candidate image, and a mode for determining the degree of similarity between two descriptors,
b) implementing, for each reference image (Iréf1, Iréf2, Iréf3, Iréf4, Iréf5, . . . , Iréfk), a reference list (L1, L2, . . . , L5, . . . , Lk) that comprises the positions, referred to as reference points of interest, in the reference image (Iréf1, Iréf2, Iréf3, Iréf4, Iréf5, . . . , Iréfk), of descriptors of the reference image that are similar to relational descriptors (Desc1′, Desc2′, Desc3′, . . . , DescN′) from a relational repository compatible with the relational repository (R), which reference list (L1, L2, . . . , L5, . . . , Lk) is ordered on the basis of the order (1, 2, 3, . . . , N′) of this compatible relational repository,
c) determining, in the candidate image (Ican), descriptors of the candidate image that are computed in line with each descriptor computing mode of the relational repository (R) implemented in step a), and determining the position of each of these descriptors in the candidate image (Ican),
d) determining the degree of similarity, determined in line with the determination mode of the relational repository (R) implemented in step a), between each descriptor of the candidate image (Ican) and each relational descriptor (Desc1, Desc2, Desc3, . . . , DescN) of the relational repository (R) implemented in step a), e) determining a candidate list (Lc) that comprises the positions, referred to as candidate points of interest, in the candidate image (Ican), of the descriptors of the candidate image exhibiting the greatest similarity with the relational descriptors (Desc1, Desc2, Desc3, . . . , DescN) of the relational repository (R) implemented in step a), which candidate list (Lc) is ordered on the basis of the order (1, 2, 3, . . . , N) of this relational repository (R), and
f) processing the candidate list (Lc) with respect to each reference list (L1, L2, . . . , L5, . . . , Lk) on the basis of the order of the candidate and reference lists.

2. The correlation method as claimed in claim 1, wherein each reference list (L1, L2, . . . , L5, . . . , Lk) implemented in step b) has been pre-established based on one and the same single relational repository, compatible with the relational repository (R) implemented in step a).

3. The correlation method as claimed in claim 2, wherein the relational repository (R) implemented in step a) is identical to the relational repository used to establish each reference list (L1, L2, . . . , L5, . . . , Lk).

4. The correlation method as claimed in claim 1, wherein the processing in step f) comprises registering the candidate list (Lc) in a form able to be used for computerized or automatic manipulation, preferably in a form analogous to that of the corresponding reference list (L1, L2, . . . , L5, . . . , Lk).

5. The correlation method as claimed in claim 1, wherein the processing in step f) comprises a step of determining the existence of homologous points of interest between the candidate list and each reference list.

6. The correlation method as claimed in claim 1, wherein the processing in step f) comprises a statistical analysis of the reference points of interest in each reference list (L1, L2, . . . , L5, . . . , Lk) and of the candidate points of interest.

7. The correlation method as claimed in claim 6, wherein the points of interest are defined by coordinates with m components and the statistical analysis is carried out on sets each formed by the coordinates or groups of coordinates of one and the same rank of the points of interest.

8. The correlation method as claimed in claim 7, wherein the sets each formed by the coordinates or groups of coordinates of one and the same rank of the candidate points of interest are classified in line with a similarity criterion with respect to the sets each formed by the coordinates or groups of coordinates of one and the same rank of the reference points of interest.

9. The correlation method as claimed in claim 5, wherein the processing in step f) comprises a geometric analysis comprising matching the candidate points of interest in the candidate list (Lc) with the homologous reference points of interest in each reference list (L1, L2, . . . , L5, . . . , Lk).

10. The correlation method as claimed in claim 9, wherein the matching is followed by determining at least one geometric transformation associating the coordinates defining the points of interest in the candidate list (Lc) with the coordinates defining the homologous points of interest in each reference list (L1, L2, . . . , L5, . . . , Lk).

11. The correlation method as claimed in claim 10, wherein the geometric transformations are classified in line with a pre-established quality criterion so as to choose which of the geometric transformations is best.

12. The correlation method as claimed in claim 10, wherein each geometric transformation sought in step f) is a direct geometric transformation between the candidate list and the reference list.

13. The correlation method as claimed in claim 10, wherein each sought geometric transformation is the result of a succession of geometric transformations between the coordinates in the candidate list (Lc) and the coordinates in the reference list (L1, L2, . . . , L5, . . . , Lk), via at least one intermediate list containing the coordinates, in any intermediate image different from the candidate image and from each reference image, of positions of descriptors of the intermediate image that are determined in line with a computing mode from a relational repository compatible with the relational repository (R) implemented in step a) and similar to the relational descriptors of this compatible relational repository.

14. The correlation method as claimed in claim 11, wherein provision is made to apply the best determined geometric transformation in order to register the candidate image (Ican) and the corresponding reference image (Iréf1, Iréf2, Iréf3, Iréf4, Iréf5, . . . , Iréfk) with one another.

15. The correlation method as claimed in claim 8, comprising a step of determining that the candidate image (Ican) belongs to a predetermined class.

16. The correlation method as claimed in claim 15, comprising a step of unitary recognition of the candidate image (Ican).

17. The correlation method as claimed in claim 16, wherein the step of unitary recognition of the candidate image (Ican) comprises iterating steps a) to f) with other reference images (Iréf1, Iréf2, Iréf3, Iréf4, Iréf5, . . . , Iréfk) and/or another relational repository (R).

18. The correlation method as claimed in claim 17, wherein each iteration of steps a) to f) is implemented on a region of interest of the candidate image (Ican) that has a reduced surface area compared to the total surface area of the initially correlated part of the candidate image (Ican).

19. The correlation method as claimed in claim 15, wherein each reference image (Iréf1, Iréf2, Iréf3, Iréf4, Iréf5, . . . , Iréfk) is a constructed image representative of at least two distinct tangible subjects belonging to one and the same class of tangible subjects.

20. The correlation method as claimed in claim 1, wherein the relational descriptors ((Desc1, Desc2, Desc3, . . . , DescN), (Desc1′, Desc2′, Desc3′, DescN′)) included in the ordered list of the relational repository (R) or of the compatible relational repository are grouped by category so as to form subsets of descriptors having at least one common characteristic.

21. The correlation method as claimed in claim 1, wherein the ordered list of relational descriptors ((Desc1, Desc2, Desc3, . . . , DescN), (Desc1′, Desc2′, Desc3′,. . . , DescN′)) of the relational repository (R) or of the compatible relational repository stems from a complex repository image.

22. The correlation method as claimed in claim 1, wherein the ordered list of relational descriptors ((Desc1, Desc2, Desc3, . . . , DescN), (Desc1′, Desc2′, Desc3′,. . . , DescN′)) of the relational repository (R) or of the compatible relational repository is optimized on the basis of the reference lists (L1, L2, . . . , L5, . . . , Lk) implemented in step b), so that the distributions of the points of interest corresponding to each of the descriptors of the reference image (Iréf1, Iréf2, Iréf3, Iréf4, Iréf5, . . . , Iréfk) are as far away as possible from one reference image (Iréf1, Iréf2, Iréf3, Iréf4, Iréf5, . . . , Iréfk) to another.

23. The correlation method as claimed in claim 1, wherein the ordered list of relational descriptors ((Desc1, Desc2, Desc3, . . . , DescN), (Desc1′, Desc2′, Desc3′, . . . , DescN′)) of the relational repository (R) or of the compatible relational repository is optimized on the basis of the reference lists (L1, L2, . . . , L5, . . . , Lk) implemented in step b), so that each point of interest corresponding to one of the descriptors of the reference image is locally distributed in each reference image (Iréf1, Iréf2, Iréf3, Iréf4, Iréf5, . . . , Iréfk).

24. The method as claimed in claim 1, wherein a candidate image (Ican) is correlated with multiple reference images (Iréf1, Iréf2, Iréf3, Iréf4, Iréf5, . . . , Iréfk).

25. The use of the correlation method as claimed in claim 15 to recognize various elements on a path with a view to establishing a digital collection of digital content, said reference images being chosen on the basis of the elements to be recognized on the path.

26. The use as claimed in claim 25, wherein provision is made, prior to the recognition of the elements, to record the digital content that is associated with each element in a memory.

27. The use as claimed in claim 25, wherein provision is made, after the recognition of the elements, to record the accessing and/or the transfer of ownership of the element, and/or the creation of a cryptographic token, and/or the accessing of a cryptographic token associated with the element in a memory or a register.

28. The use as claimed in claim 25, wherein provision is made for a step of recognizing the user and/or the device used to generate the candidate image, prior to the recognition of the elements.

29. A method for creating a reference list (L1, L2, . . . , L5, . . . , Lk) from a reference image (Iréf1, Iréf2, Iréf3, Iréf4, Iréf5, . . . , Iréfk), comprising the following steps: implementing a relational repository comprising at least: an ordered list of relational descriptors (Desc1′, Desc2′, Desc3′, . . . , DescN′), at least one computing mode to be applied to the reference image (Iréf1, Iréf2, Iréf3, Iréf4, Iréf5, . . . , Iréfk) in order to determine descriptors of this image, and a mode for determining the degree of similarity between two descriptors, and
determining descriptors of the reference image, computed in line with each descriptor computing mode of the relational repository, and determining the position of each of these descriptors in the reference image, determining the degree of similarity, determined in line with the determination mode of the relational repository, between each descriptor of the reference image and each relational descriptor of the relational repository,
determining a reference list comprising the positions, referred to as reference points of interest, in the reference image (Iréf1, Iréf2, Iréf3, Iréf4, Iréf5, . . . , Iréfk), of each descriptor of the reference image exhibiting the greatest similarity with the corresponding relational descriptor (Desc1′, Desc2′, Desc3′, . . . , DescN′) and that is ordered on the basis of the order of the relational repository.

30. The method as claimed in claim 29, wherein a set of reference lists is created by iterating the determining steps of claim 29, based on the implementation of mutually compatible relational repositories.
